(19) United States
(12) Patent Application Publication
(10) Pub. No.: US 2021/0326030 A1
(43) Pub. Date: Oct. 21, 2021

(54) Process For The Measurement Of A Physical Measured Variable And Measuring System For Carrying Out The Process

(71) Applicant: Kistler Holding AG, Winterthur (CH)

(72) Inventors: Marco Angliker, Zürich (CH); Frederic De Simoni, Aarau (CH)

(21) Appl. No.: 17/272,447

(22) PCT Filed: Sep. 12, 2019
(86) PCT No.: PCT/EP2019/074376

§ 371 Date: Mar. 1, 2021

(30) Foreign Application Priority Data
Sep. 21, 2018 (EP) 18195965.1

(51) Int. Cl. G06F 3/0484; G01L 19/00; G01K 7/02; G06F 3/0481

(52) U.S. Cl. CPC G06F 3/04847; G01L 19/0092; G01K 7/02; G06F 2203/04803; G06F 3/04842; G06F 3/0481; G06F 3/04845

(57) ABSTRACT

A process for the measurement of a physical measured variable by using process parameters of a measuring system, which process parameters include a plurality of measuring units of the physical measured variable includes the step of detecting the physical measured variable and generating a measurement signal. Then the measurement signal is evaluated to generate a measured variable. A representation of the measurement signal or measured variable is generated. The measurement signal or measured variable is then processed to yield a computer program product for the setting and monitoring of process parameters. Each process parameter is displayed in a respective window of a graphical user interface. Each window is sized selectively to display the corresponding process parameter in a short form or a long form.

### CROSS-REFERENCE TO RELATED APPLICATIONS

The present application claims priority to patent application serial number PCT/EP2019/074376, filed on Sep. 12, 2019, which patent application is hereby incorporated herein in its entirety by this reference for all purposes.

### FIELD OF THE INVENTION

The present invention relates to a process for the measurement of a physical measured variable and a measuring system for carrying out the process that includes displaying process parameters in windows of a graphical user interface.

### BACKGROUND OF THE INVENTION

A physical measured variable is measured using a measuring unit. The physical measured variable may be a force, a pressure, a mass, a temperature, etc. Usually, this measuring process requires a plurality of temporally and spatially separated process steps. A pressure is measured in a measuring chamber, for example. For this purpose, a piezoelectric pressure sensor disposed in the measuring chamber detects the pressure and generates an amount of electrical charges that is proportional to the pressure detected. This amount of electrical charges is transmitted as the measurement signal by means of a signal cable to an evaluation unit, which is located in a spatial distance from the measuring chamber, and is where the measurement signal is evaluated to obtain a measured variable. A measuring unit of this type thus comprises a plurality of transmission elements such as a sensor, measuring cable and an evaluation unit, said transmission elements forming a measuring chain. There is a cause-and-effect relationship between directly adjacent transmission elements in the measuring chain during the measurement of the physical measured variable.

Often, a plurality of measuring units together form a measuring system. In an example, a cylinder pressure of eighteen cylinders of a marine engine is measured as the physical measured variable continuously over a period of several weeks. The cylinder pressure is several 100 bar, a cylinder temperature is several 100° C. In this example, the measuring system comprises eighteen measuring units. Each measuring unit comprises a piezoelectric pressure sensor and a thermocouple which record the cylinder pressure and the cylinder temperature of one cylinder. A measurement frequency is 10 kHz. Each measuring unit comprises a measuring cable for transmitting the measurement signals to an evaluation unit. The evaluation unit itself comprises 36 measuring channels so that it can receive the measurement signals in a cylinder-specific manner. The evaluation unit electrically amplifies the measurement signals and displays the electrically amplified measurement signals as the measured variables and stores said measured variables.

Thus, the measuring system comprises many process parameters such as the measuring units, the detection of the physical measured variable, the evaluation of the measurement signal for obtaining a measured variable, and so on. Most of these process parameters of the measuring system must be adjusted and all process parameters of the measuring system must be monitored. Therefore, it is necessary to establish which piezoelectric pressure sensor and which thermocouple are arranged at a certain cylinder or which measuring cable is connected to a particular measuring channel of the evaluation unit, etc. Furthermore, it must be monitored whether the cylinder pressure and cylinder temperature measured for the marine engine conform with predetermined limit values and an alarm is given in the event of non-conformance. In addition, it is necessary to be able to start and stop measurements and to change process parameters, for example in the event of a defective measuring cable that must be replaced. For this purpose, the measuring system comprises a computer program product for the setting and monitoring of process parameters. The computer program product may be operated via a graphical user interface (GUI). A user of the measuring system may operate and monitor the measuring system via the graphical user interface and start and stop measurements. The graphical user interface comprises windows. The windows serve for displaying information on the measuring system. However, also control signals for the setting and monitoring of process parameters and for the starting and stopping of measurements may be entered into the windows.

The computer program product comprises a large number of windows to account for the wide variety and the large number of process parameters. This large number of windows is often nested hierarchically which has an adverse effect on the clarity and transparency of the graphical user interface. Thus, information concerning a number of measuring channels for receiving the measurement signals is displayed in a fourth window from the top of a window stack, for example. However, the fourth window from the top may be hidden behind three overlying windows of the window stack. Therefore, the fourth window from the top is only visible in the graphical user interface after the three overlying windows of the window stack have been opened successively. Thus, it is necessary to first open or move three overlying windows of the window stack before the information can be displayed. A graphical user interface of this type is cumbersome to use.

### OBJECTS AND SUMMARY OF THE INVENTION

It is a first object of the present invention to provide a process for the measurement of a physical measured variable, which process uses a computer program product for the setting and monitoring of process parameters, which computer program product can be easily used via a graphical user interface and is clear and transparent. A further object of the invention is to provide a measuring system for carrying out said process.

These objects have been achieved by the features described below.

The invention relates to a process for the measurement of at least one physical measured variable by using process parameters of a measuring system. The process parameters include a plurality of measuring units required for measuring the physical measured variable. The process parameters comprise the process steps of at least one detection of the physical measured variable as the measurement signal, at least one evaluation of the measurement signal for obtaining a measured variable, at least one representation of the measurement signal or measured variable and at least one processing of the measurement signal or measured variable. A computer program product is included for the setting and monitoring of the process parameters and configured so that each process parameter is displayed on a graphical user interface in a window that may be collapsed to a window that uses precisely the space on the graphical user interface that is needed to display the corresponding process parameters in short form. The computer program product is configured so that each window may be opened, and an opened window uses precisely the space on the graphical user interface that is needed to display the corresponding process parameters in long form.

The selective opening and closing of windows that are dedicated to the process parameters creates space on the graphical user interface so that information is represented in a clear and transparent manner. All process parameters are displayed in windows specifically assigned thereto. In collapsed windows the process parameters are shown in short form and in opened windows the process parameters are represented in long form. The computer program product is configured so that a user of the measuring system may open and close windows depending on the information content desired.

The invention also relates to a measuring system for carrying out the process, wherein the process parameters are classified in categories, a first category of process parameters comprises a plurality of measuring units required for the measurement of the physical measured variable, a second category comprises at least one detection of the physical measured variable as the measurement signal, a third category comprises at least one evaluation of the measurement signal for obtaining a measured variable, a fourth category comprises at least one representation of the measurement signal or measured variable, and a fifth category comprises at least one processing of the measurement signal or measured variable. Each category is assigned a unique index number; and wherein the computer program product displays in at least two columns on the graphical user interface the windows of process parameters having the same index number.

This category-specific representation of process parameters is clear and transparent. Preferably, by activating and deactivating a column it is thus easily possible to manage the information content displayed in the windows in a category-specific manner. In a deactivated column the windows are closed and the process parameters are shown in short form; in an activated column the windows are opened and the process parameters are shown in long form. The computer program product is configured so that a user of the measuring system may activate and deactivate columns depending on the information content that he or she desires.

### BRIEF DESCRIPTION OF THE DRAWINGS

In the following, the present invention will be explained in more detail by way of example with respect to the figures in which:

FIG. 1 shows a block diagram showing process parameters of a measuring system;

FIG. 2 shows a schematic view of an electronic computing unit for executing a computer program product for the setting and monitoring of process parameters of the measuring system according to FIG. 1;

FIG. 3 shows a schematic view of a first exemplary embodiment of a graphical user interface of a computer program product for the setting and monitoring of process parameters of the measuring system according to FIG. 1;

FIG. 4 shows a schematic view of a still deactivated first column of the embodiment of a graphical user interface according to FIG. 3;

FIG. 5 shows a schematic view of the activated first column of the embodiment of a graphical user interface according to FIG. 4;

FIG. 6 shows a schematic view of a still deactivated window of the activated first column of the embodiment of a graphical user interface according to FIG. 5;

FIG. 7 shows a schematic view of the activated window of the activated first column of the embodiment of a graphical user interface according to FIG. 6;

FIG. 8 shows a schematic view of a still deactivated fourth column of the embodiment of a graphical user interface according to FIG. 7;

FIG. 9 shows a schematic view of the activated fourth column of the embodiment of a graphical user interface according to FIG. 8; and

FIG. 10 shows a schematic view of a second exemplary embodiment of a graphical user interface of a computer program product for the setting and monitoring of process parameters of the measuring system according to FIG. 1.

### DETAILED DESCRIPTION OF EXEMPLARY EMBODIMENTS

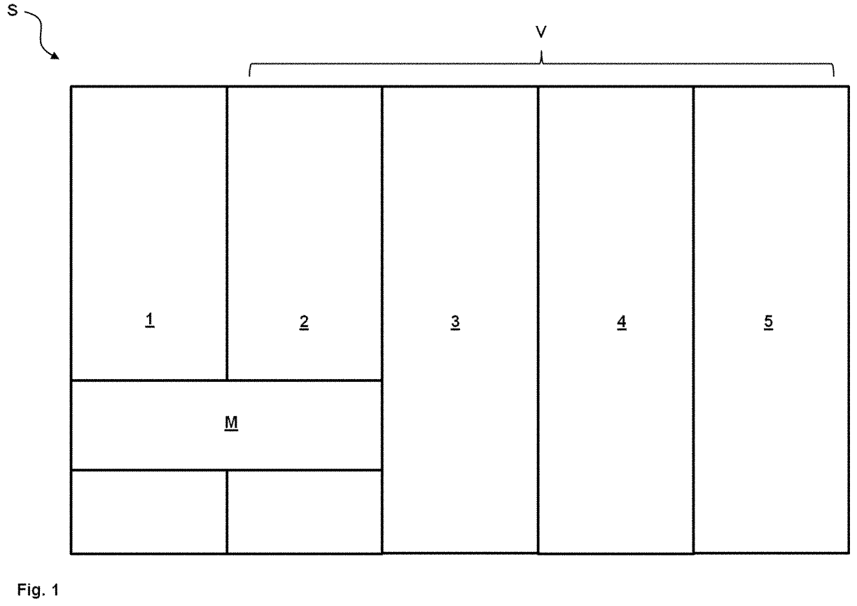

FIG. 1 shows process parameters of a measuring system S. At least one physical measured variable M is measured using the measuring system S. The physical measured variable M may be a force, a pressure, a mass, a temperature, etc. The process parameters are divided into a plurality of categories.

A first category of process parameters comprises at least one measuring unit 1 required for measuring the physical measured variable M. Each measuring unit 1 comprises a plurality of transmission elements such as at least one sensor, at least one measuring cable and at least one evaluation unit. A measuring unit 1 measures at least one physical measured variable M, however, it may also measure more than one physical measured variable M. The measuring unit 1 and its transmission elements are also referred to as measurement setup.

A second, third, fourth and fifth category of process parameters comprise process steps of a process V. Thus, a second category of process parameters comprises the process step of at least one detection 2 of a physical measured variable M as the measurement signal. A third category of process parameters comprises the process step of at least one evaluation 3 of the measurement signal for obtaining at least one measured variable. The evaluation 3 is also called data processing. A fourth category of process parameters comprises the process step of at least one representation 4 of the measurement signal or measured variable. The representation 4 of the measurement signal or measured variable may be in the form of a table, a graph, etc. Furthermore, a fifth category of process parameters comprises the process step of at least one processing 5 of the measurement signal or measured variable. The processing 5 of the measurement signal or measured variable may be a use thereof as a trigger signal for a downstream process such as a detection of good/bad parts in an injection molding process, a data transmission to a memory at a spatially distant location, a data transfer to a data processor at a spatially distant location, etc.

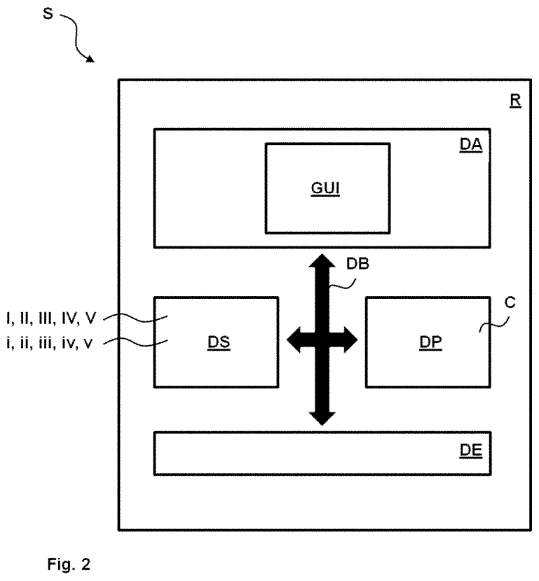

FIG. 2 shows a schematic view of an electronic computing unit R for executing a computer program product C of the measuring system S. The components of the electronic computing unit R comprise at least one data memory DS, at least one data processor DP, at least one data input device DE, at least one data output device DA and at least one data bus DB. Any type of data may be exchanged between the components via the data bus DB.

The data input device DE and data output device DA may be separate components such as a keyboard, a computer mouse, a computer screen, a serial interface, etc., however, they may also be integrated in one component such as a touch screen. The data output device DA comprises at least one screen or touch screen having a graphical user interface GUI.

Thus, at least one computer program product C that is stored in the form of data in the data memory DS may be loaded from the data memory DS in the form of data via the data bus DB into the data processor DP. After having been loaded the computer program product C is executed by the data processor DP.

The computer program product C is able to read both data of at least one measurement signal and data of at least one measured variable from a data input device DE, for example a serial interface, via the data bus DB. Therefore, the computer program product C is able to perform the evaluation 3 of the measurement signal for obtaining a measured variable, it may also perform the representation 4 of the measurement signal and the measured variable, and it may perform the processing 5 of the measurement signal or measured variable. However, the evaluation 3 of the measurement signal for obtaining a measured variable, the representation 4 of the measurement signal and measured variable, and the processing 5 of the measurement signal and measured variable may also be performed in an analysis unit that is located remotely in a spatial distance from the electronic computing unit R.

The process parameters are stored as data in the data memory DS and may be retrieved from the data memory DS.

The categories are indexed. Preferably, a unique index number is assigned to each category. The index number of the first category is I, the index number of the second category is II, the index number of the third category is III, the index number of the fourth category is IV, and the index number of the fifth category is V. The index number is a characteristic of the process parameters and is stored together with the data of the process parameters in the data memory DS and may be retrieved from the data memory DS.
The process parameters of one measuring unit 1 are linked to each other. Preferably, each measuring unit 1 has a unique identification number and the process parameters are linked to each other by this identification number. The identification number of a first measuring unit is i, the identification number of a second measuring unit is ii, the identification number of a third measuring unit is iii, the identification number of a fourth measuring unit is iv, and the identification number of a fifth measuring unit is v, etc. The identification number is a characteristic of the process parameters, for example, and is stored together with the data of the process parameters in the data memory DS and may be retrieved from the data memory DS. The process parameters of one measuring unit 1 may be linked to each other from left to right or from right to left. In the case where the process parameters of a measuring unit 1 are linked from left to right as in the system S of FIG. 1 for example, two or more process parameters are linked to each other in a causal and chronological sequence of the process steps of detection 2, evaluation 3, representation 4 and processing 5. In the case where the process parameters of a measuring unit 1 are linked from right to left, however, two or more process parameters are linked to each other in a non-causal and non-chronological sequence of process steps, for example a representation 4 may be linked to an evaluation 3 that was carried out at an earlier time.

The computer program product C schematically shown in FIG. 2 is configured to read data of process parameters of the measuring system S depicted in the block diagram of FIG. 1. The computer program product C is configured with the capability to import process parameters stored as data in the data memory DS from the data memory DS via the data bus DB into the data processor DP.

The computer program product C is configured with the capability to set and monitor process parameters of the measuring system S. Setting a process parameter means to change the state of the process parameter. For example, a measurement is started or terminated by inputting a control signal for the process step of detecting 2 the physical measured variable M. Monitoring of a process parameter refers to the representation 4 of the time course of the process parameter. For example, a detailed representation of a measurement signal or measured variable is done by displaying a time course of the measurement signal or measured variable in the form of a graph. The computer program product C is configured to transmit data of a control signal via the data bus DB to the data output device DA, for example a serial interface. From the data output device DA, the data of the control signal are transmitted to a measuring unit 1 such as a sensor or an evaluation unit.

The computer program product C outputs information about the measuring system S on the graphical user interface GUI. For this purpose, the graphical user interface GUI comprises columns comprising windows. The computer program product C is configured to transmit information data to the graphical user interface GUI via the data bus DB and to put the data out as information in the columns comprising windows.

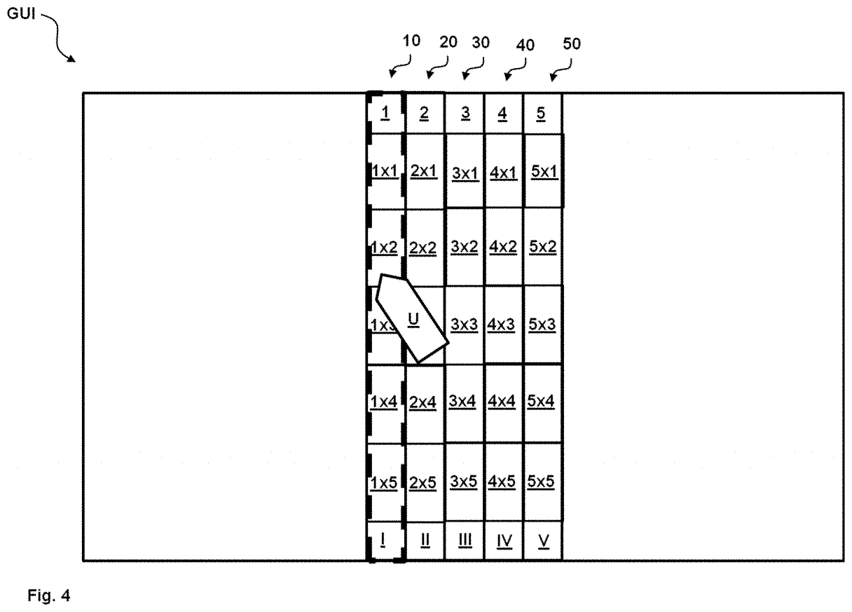

The computer program product C is configured to be operated via the graphical user interface GUI. Operating the computer program product C means to input control signals. Control signals for the setting and monitoring of process parameters may be entered in the columns comprising windows. Thus, the data input device DE may be a computer mouse which moves a cursor U across the graphical user interface GUI as shown in FIG. 4 for example. A column comprising windows or a window is selected by moving the cursor U across the graphical user interface GUI. A control signal is entered by activating a selected column comprising windows or a selected window over which the cursor U is placed. The activation may be achieved by pressing a button of the computer mouse when the cursor U is over a selected column comprising windows or a selected window. Data for moving the cursor and for activating the column comprising windows or the window are transmitted from the data input device DE to the data output device DA of the graphical user interface GUI as well as to the computer program product C via the data bus DB. The movement of the cursor and the activation of the selected column comprising windows or the selected window over which the cursor is placed may also be achieved by manually swiping across a touch screen of a graphical user interface GUI and by manually pressing on the touch screen of the graphical user interface GUI.

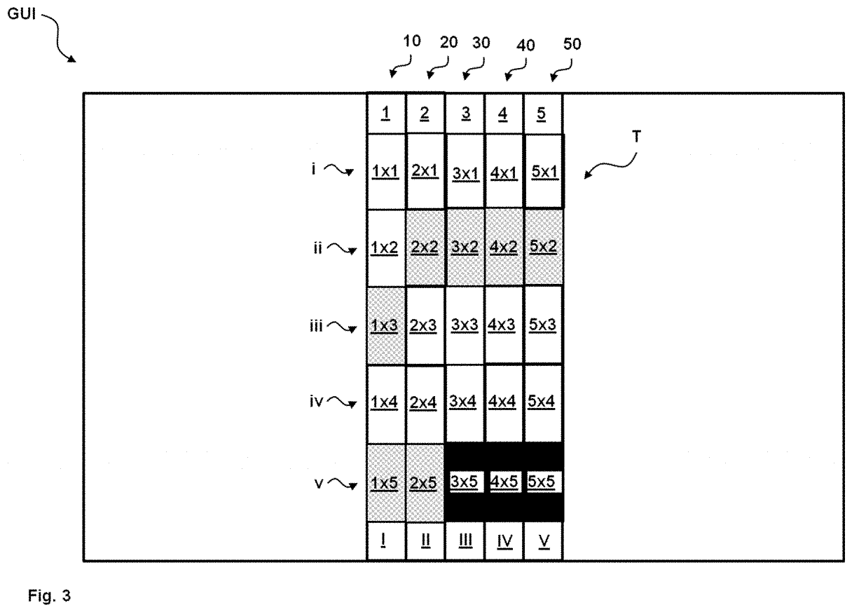

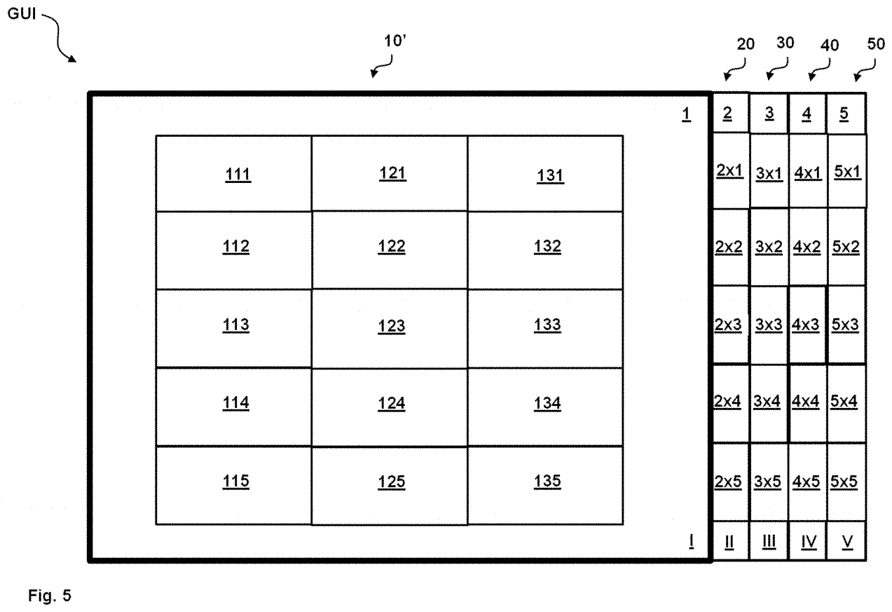

FIGS. 3 to 10 show two exemplary embodiments of a graphical user interface GUI of the computer program product C schematically shown in FIG. 2 for the setting and monitoring of process parameters of the measuring system S depicted in block diagram format in FIG. 1. For example, in each of FIGS. 3-10, the graphical user interface GUI comprises five columns 10 to 50. In each of FIGS. 5-9, windows are designated 10′, 40′. The measuring system S carries out five different measurements of physical measured variables M simultaneously by means of five measuring units 1, for example. Each of the measuring units 1 is able to measure at least one physical measured variable M at the same time. Each process parameter of each of the measurements is displayed in a window specifically assigned thereto on the graphical user interface GUI. Preferably, each column 10 to 50, 10′, 40′ shows the windows of process parameters of one and the same category. Preferably, in each column 10 to 50, 10′, 40′ the computer program product C displays the windows of process parameters having the same index number I to V.

FIG. 3 shows a first embodiment of the graphical user interface GUI.

A first column 10 in FIG. 3 shows process parameters of the first category from five measuring units 1. Each measuring unit 1 has a unique identification number i, ii, iii, iv and v. The first column 10 is deactivated and shows five collapsed windows 1×1 to 1×5. Each collapsed window 1×1 to 1×5 shows the measuring units 1 of one of the five measurements in short form.

A second column 20 shows process parameters of the second category of detecting 2 the physical measured variables M as measurement signals in five measurements. The second column 20 is deactivated and shows five collapsed windows 2×1 to 2×5. Each collapsed window 2×1 to 2×5 shows the detection 2 of the physical measured variable M to be detected as the measurement signal in one of five measurements in short form.

A third column 30 shows process parameters of the third category of evaluating 3 the measurement signal for obtaining a measured variable for the five measurements. The third column 30 is deactivated and shows five collapsed windows 3×1 to 3×5. Each collapsed window 3×1 to 3×5 shows the evaluation 3 of the measurement signal for obtaining a measured variable for the five measurements in short form.

A fourth column 40 shows process parameters of the fourth category of representing 4 the measurement signal or measured variable for the five measurements. The fourth column 40 is deactivated and shows five collapsed windows 4×1 to 4×5. Each collapsed window 4×1 to 4×5 shows the representation 4 of the measurement signal or measured variable for the five measurements in short form.

A fifth column 50 shows process parameters of the fifth category of processing 5 of the measurement signal or measured variable for the five measurements. The fifth column 50 is deactivated and shows five collapsed windows 5×1 to 5×5. Each collapsed window 5×1 to 5×5 shows the processing 5 of the measurement signal or measured variable for the five measurements in short form.

A deactivated column with collapsed windows as schematically shown in FIG. 3 for example uses precisely the space on the graphical user interface GUI that is needed to display the corresponding process parameters in the collapsed windows in short form. Preferably, a column with collapsed windows uses a minimum space of less than 5% of the graphical user interface GUI. A representation of a process parameter in short form is an abstract representation of a process parameter such as a pictogram or a sequence of letters and numbers. For example, a measuring unit 1 comprising a pressure sensor may be displayed in short form as “Type 603C” or “MU-A-A111-Slot_1”. A detection 2 of a physical measured variable M may be displayed in short form as “pressure signal 2” or “acceleration signal 5”. An evaluation 3 of the measurement signal for obtaining a measured variable may be shown in short form as “Measured variable 3” or “OK” for indicating “available” in an abbreviated form. A representation 4 of a measurement signal or measured variable may be displayed in short form as “Graph_1” or “Measurement inaccuracy 2”. And a processing 5 of a measurement signal or measured variable may be displayed in short form as “Trigger signal 2” or “OK” for indicating “data transmission has occurred” in an abbreviated form.

The embodiment of the graphical user interface GUI according to FIG. 3 shows five deactivated columns 10 to 50 comprising 25 collapsed windows 1×1 to 5×5. By way of example, the 25 collapsed windows 1×1 to 5×5 use less than 25% of the graphical user interface GUI.

A status notification T of the process parameters of the measuring system S may be displayed in the graphical user interface GUI as schematically shown in FIG. 3 for example. The computer product program is configured so that the status notification T is activatable, which means that the status notification T may be switched on and switched off. In the embodiment of the graphical user interface GUI according to FIG. 3 the status notification T is activated.

For example, the status notification T of the measuring units 1 indicates whether or not a measurement of a physical measured variable M is currently carried out.

For example, the status notification T of the detection 2 of the physical measured variables M in the form of measurement signals indicates whether or not a physical measured variable M is currently being recorded as measurement signals.

For example, the status notification T of the evaluation 3 of the measurement signal for obtaining a measured variable indicates whether or not an evaluated measured variable is currently within predefined limit values.

For example, the status notification T of the representation 4 of the measurement signal or measured variable indicates whether or not a measurement signal or measured variable may be currently represented.

For example, the status notification T of the processing 5 of the measurement signal or measured variable indicates whether or not a measurement signal or measured variable is currently being processed.

In the embodiment of the graphical user interface GUI according to FIG. 3 the status notification T is graphically represented in the windows 1×5 to 5×5 in traffic light colors white, grey and black.
In the example in FIG. 3, the status notification T indicates that no measurement of a physical measured variable M is currently carried out for the measuring units 1 having the identification numbers i, ii and iv. The background of the windows 1×1 to 5×1 of identification number i, the windows 1×2, 2×3 to 5×3 of identification number ii, and the windows 1×4 to 5×4 of identification number iv is white to indicate that no measurements are currently taking place.

In this example depicted in FIG. 3, measurements of a physical measured variable M are currently performed for the measuring units 1 with identification numbers iii and v. The background of the windows 1×3 to 2×2 of identification number iii and the windows 1×5 to 2×5 of identification number v is grey indicating that measurements are currently taking place and that measured variables M are currently being recorded as measurement signals.

In the example depicted in FIG. 3, an evaluated measured variable of the identification number iii is currently within predefined limit values and may be displayed and processed. The background of the windows 3×2 to 5×2 of identification number iii is grey to indicate that here the measurement of the physical measured variable M takes place in a proper fashion.

In the example depicted in FIG. 3, an evaluated measured variable of identification number v is currently beyond predefined limit values and cannot be displayed and also will not be processed. The background of the windows 3×5 to 5×5 of identification number v is black indicating that the measurement of the physical measured variable M is not taking place in a proper fashion.

Those skilled in the art and being aware of the present invention may implement other status notifications such as an availability of a measuring unit, etc. Those skilled in the art may display a status notification using other graphical means and/or acoustic means.

FIG. 4 is a schematic representation that shows the graphical user interface GUI in the embodiment according to FIG. 3 with deactivated first column 10. In contrast to FIG. 3, a cursor U has been moved over the first column 10 in FIG. 4. The intention to activate the deactivated first column 10 is indicated by a bold dashed border around the first column 10.

FIG. 5 is a schematic representation that shows the graphical user interface GUI in the embodiment of FIG. 4 with activated first column 10′. A bold solid border around the first column 10′ indicates that the first column 10′ has been activated. An activated first column 10′ displays the measuring units 1 required for the five measurements. The activation of the first column 10′ has opened the windows 111 to 135 of the first column 10′. The activated first column 10′ comprises three sub-columns with opened windows 111 to 115 for sensors, opened windows 121 to 125 for measuring cables and opened windows 131 to 135 for evaluation units, for example.

An activated column with opened windows uses precisely the space on the graphical user interface GUI that is necessary to display the corresponding process parameter in long form. Preferably, an activated column with opened windows uses a maximum space of more than 50% of the graphical user interface GUI. A representation of a process parameter in long form is a detailed representation as schematically shown in FIG. 5. Thus, a measuring unit 1 comprising a pressure sensor and a thermocouple may show in long form an extract of a data sheet of the pressure sensor with a detailed description of the interfaces and a description of the physical measured variables “Cylinder pressure 3”, “Cylinder temperature 3” that are measured. A detection 2 of a physical measured variable M may be displayed in long form as “Maximum pressure signal 2=218 bar” or “Acceleration signal 5=1.5 g”. An evaluation 3 of the measurement signal for obtaining a measured variable may be displayed in long form as “Measurement inaccuracy 2=5.3%” or in form of the phrase “Measured variable 3 is within the limit values set”, etc. A representation 4 of a measurement signal or measured variable may be displayed in long form as a graphical representation of the time course of a “Pressure signal 2”. Moreover, a processing 5 of a measurement signal or measured variable may be displayed in long form as the phrase “Transmitted data volume=9.2 MB/s”.

It will be clear for the skilled artisan being aware of the present invention that a deactivation of an activated column is achieved analogously to the activation of a deactivated column. An activated column is deactivated by moving a cursor U to select a column and clicking so that the windows of the deactivated column are collapsed.

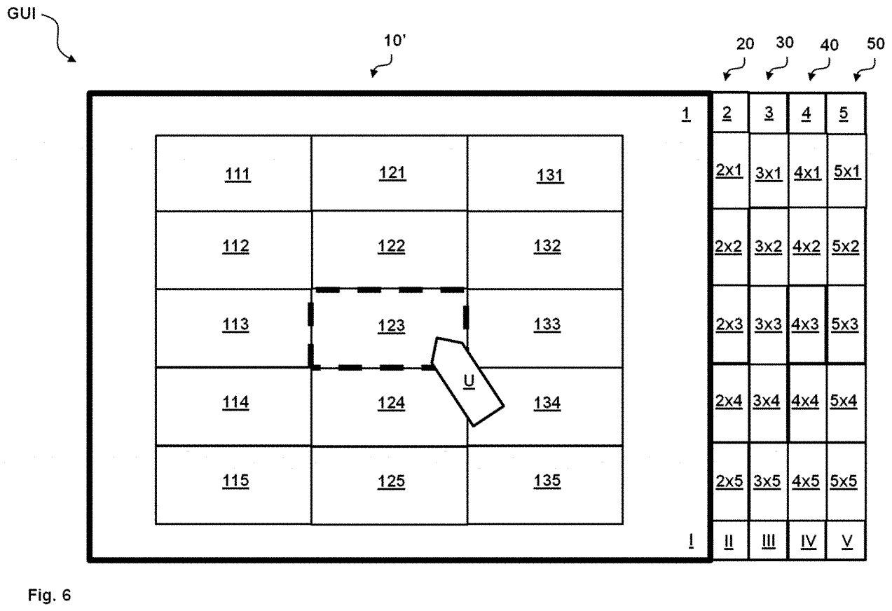

FIG. 6 shows the graphical user interface GUI in the embodiment according to FIG. 5 with window 123 of the activated first column 10′ still deactivated. In contrast to FIG. 5, a cursor U has been moved over the deactivated window 123 in FIG. 6. The intention to activate the deactivated window 123 is indicated by a bold dashed border around window 123.

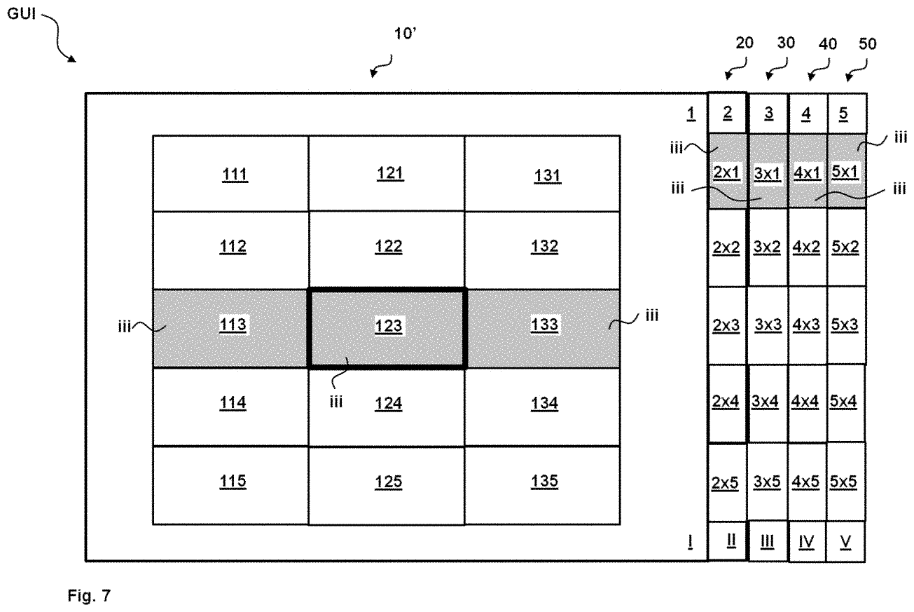

FIG. 7 shows the graphical user interface GUI in the embodiment according to FIG. 6 with activated window 123 of the activated first column 10′. The activation of the window 123 is indicated by a bold solid border around window 123. The activation of the window 123 has selected windows 113, 123 and 133 in the first column 10′, window 2×1 in the second column 20, window 3×1 in the third column 30, window 4×1 in the fourth column 40, and window 5×1 in the fifth column 50. The selection of windows 113, 123, 133, 2×1, 3×1, 4×1 and 5×1 is indicated by grey hatching. The selection is easily recognized on the graphical user interface GUI by users of the measuring system S. The selection indicates that these process parameters belong to one and the same measuring unit 1. Preferably, as schematically shown in FIG. 6, the computer program product C is configured so that it selects all windows of process parameters that belong to the same measuring unit 1 as the process parameter of the activated window 123 and thus have the same identification number iii as the process parameter of the activated window 123. Thus, window 113 represents in long form the sensor used by measuring unit 1. Window 123 represents in long form the measuring cable used by measuring unit 1. Window 133 represents in long form the evaluation unit used by measuring unit 1. Window 2×1 shows for measuring unit 1 the process step of detection 2 of the physical measured variable M as the measurement signal in short form. Window 3×1 shows for measuring unit 1 the process step of evaluating 3 the measurement signal for obtaining a measured variable in short form. Window 4×1 shows for measuring unit 1 the process step of representing 4 the measurement signal or measured variable in short form. Window 5×1 shows for measuring unit 1 the process step of processing 5 of the measurement signal or measured variable in short form.

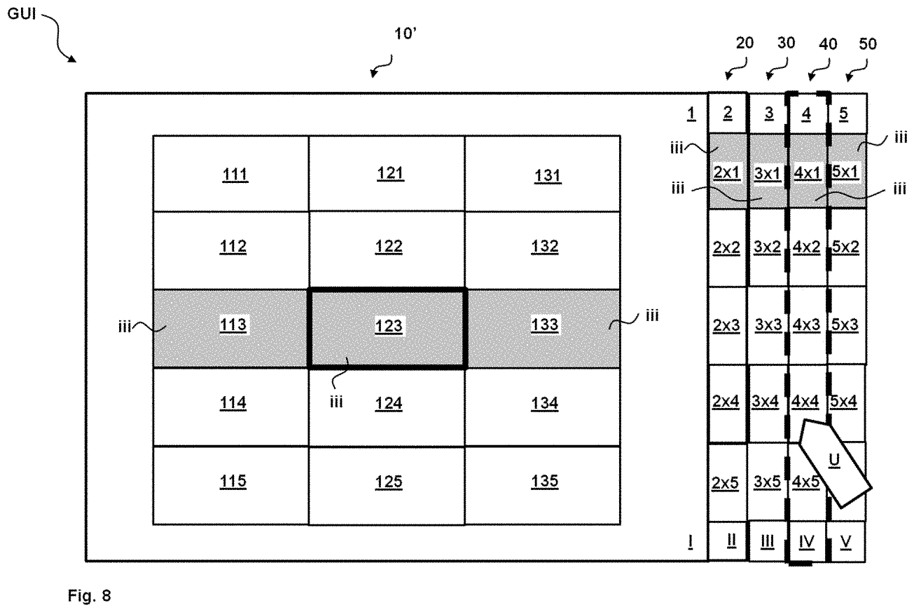

FIG. 8 shows the graphical user interface GUI in the embodiment according to FIG. 7 with still deactivated fourth column 40. In contrast to FIG. 7, a cursor U has been moved over the fourth column 40 in FIG. 8. The intention to activate the still deactivated fourth column 40 is indicated by a bold dashed border around the fourth column 40.

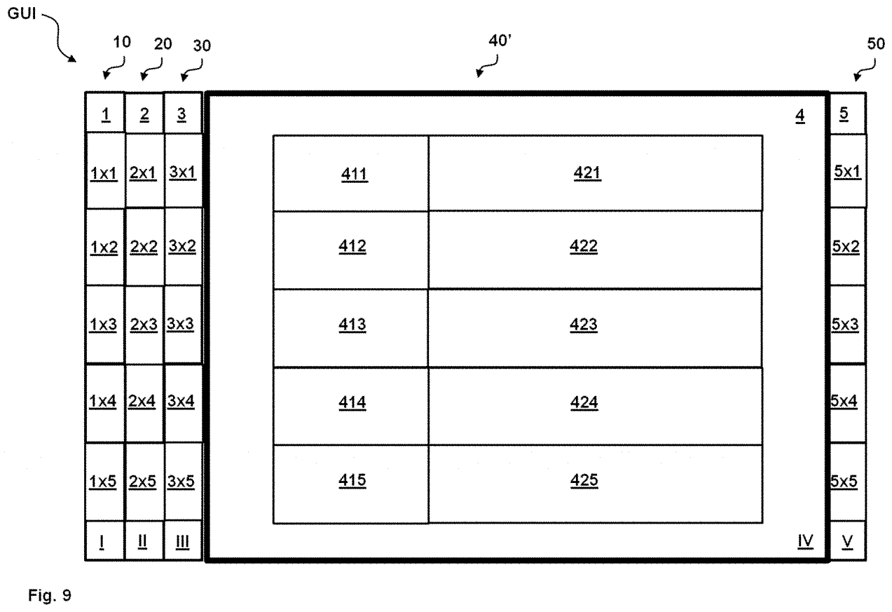

FIG. 9 shows the graphical user interface GUI in the embodiment according to FIG. 8 with the fourth column 40′ activated. The activation of the fourth column 40′ is indicated by a bold solid border around the fourth column 40′. An activated fourth column 40′ displays the representation 4 of a measurement signal or measured variable of the five measurements. The activation of the fourth column 40′ has opened windows 411 to 425 of the fourth column 40′. The computer program product C is configured so that activation of the fourth column 40′ has not only closed windows 111 to 135 of the first activated column 10′ but has also deactivated the first column 10 altogether. For example, the activated fourth column 40′ comprises two sub-columns with opened windows 411 to 415 for a detailed display of the measurement signal or measured variable and with opened windows 421 to 425 for a graphical representation of the time course of the measurement signal or measured variable.

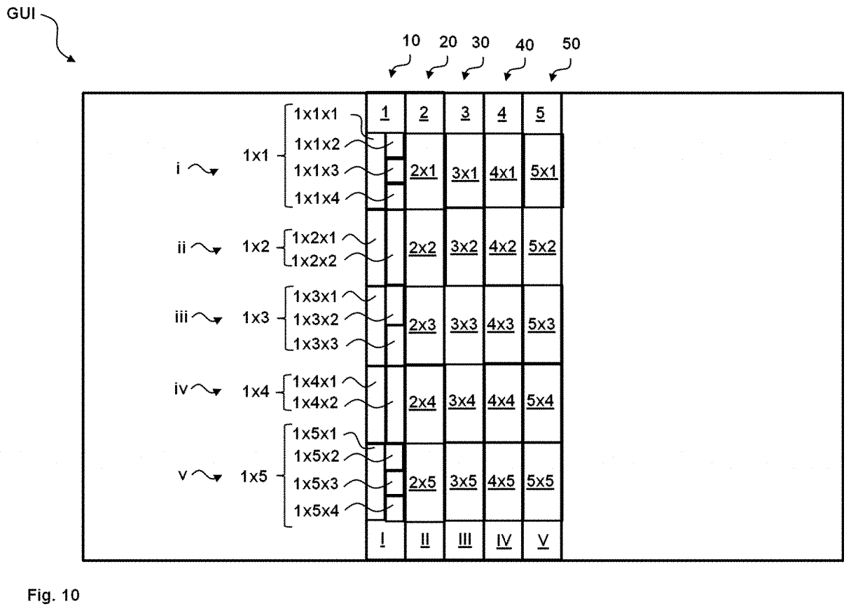

FIG. 10 shows a second embodiment of the graphical user interface GUI. The embodiment according to FIG. 10 is substantially similar to the one according to FIG. 3 so that reference is made to the description thereof, only the differences between these two embodiments will be explained in the following.

Thus, the graphical user interface GUI according to FIG. 10 comprises a first column 10 with collapsed windows 1×1 to 1×5, which collapsed windows 1×1 to 1×5 have a fine structure 1×1×1 to 1×5×4. Despite the minimum space used by the collapsed windows, the fine structure displays the process parameter of the measuring unit 1 required for measuring the physical measured variable in short form in a distinctive manner. A representation of measuring unit 1 in a distinctive short form is an abstract representation of the measuring unit 1 by a pictogram or a sequence of letters and numbers with additional information, such as a representation of different measuring channels or different measuring ranges of the measuring unit 1, being also provided.

In the example of FIG. 10, the fine structure 1×1×1 to 1×1×4 and 1×5×1 to 1×5×4a represents a measuring unit 1 having the identification number i, v and comprising a force sensor and three measuring channels for each force sensor. A first fine structure 1×1×1, 1×5×1 shows the force sensor in short form as “Type 9047C”, “Type 9047C”. Another fine structure 1×1×2 to 1×1×4, 1×5×2 to 1×5×4 shows in short form three measuring channels for each force sensor as “Channel X”, “Channel Y” and “Channel Z”.

In the example of FIG. 10, the fine structure 1×2×1 and 1×2×2 and 1×4×1 and 1×4×2 represents a measuring unit 1 having the identification number ii, iv and comprising a thermocouple and one measuring channel for each thermocouple. A first fine structure 1×2×1, 1×4×1 shows the thermocouple in short form as “Type K”. Another fine structure 1×2×1, 1×4×2 shows the measuring channel for each thermocouple in short form as “Channel K”.

In the example of FIG. 10, the fine structure 1×3×1 to 1×3×3 represents a measuring unit 1 having the identification number iii and comprising a pressure sensor and two measuring ranges. A first fine structure 1×3×1 shows the force sensor in short form as “Type 603C”. Another fine structure 1×3×2 to 1×3×3 shows two measuring ranges of the pressure sensor in short form as “Range 1” and “Range 2”.

In the example of FIG. 10, the fine structure 1×3×1 to 1×3×3 represents a measuring unit 1 having the identification number iii and comprising a pressure sensor and two measuring ranges. A first fine structure 1×3×1 shows the force sensor in short form as “Type 603C”. Another fine structure 1×3×2 to 1×3×3 shows two measuring ranges of the pressure sensor in short form as “Range 1” and “Range 2”.

Those skilled in the art being aware of the present invention may display other or all process parameters in specifically assigned windows that have a fine structure.

Furthermore, no status notification T is activated in the graphical user interface GUI according to FIG. 10.

### LIST OF REFERENCE NUMERALS

| 1 | measuring unit | |
|---|---|---|
| 2 | detection of the measurement signal | |
| 3 | evaluation of the measurement signal | |
| 4 | representation of the measurement signal or measured variable | |
| 5 | processing of the measurement signal or | |
| 6 | measured variable | |
| 7 | 10 bis 50 column | |
| 8 | 10′, 40′ activated column | |
| 9 | 1 × 1 bis 5 × 5 | collapsed window |
| 10 | 1 × 1 × 1 bis 1 × 5 × 4 | fine structure |
| 11 | 111 bis 135 | opened window |
| 12 | 411 bis 425 | opened window |
| 13 | C | computer program product |
| 14 | DA | data output device |
| 15 | DB | data bus |
| 16 | DE | data input device |
| 17 | DP | data processor |
| 18 | DS | data memory |
| 19 | GUI | graphical user interface |
| 20 | i bis v | identification number |
| 21 | I bis V | index number |
| 22 | M | physical measured variable |
| 23 | R | electronic computing device |
| 24 | S | measuring system |
| 25 | T | status notification |
| 26 | U | cursor |
| 27 | V | process |

1. A process for the measurement of at least one physical measured variable by using process parameters of a measuring system that includes at least one measuring unit required for measuring the physical measured variable, the process including the steps of:
detection of the physical measured variable as a measurement signal,
evaluation of the measurement signal for obtaining a measured variable,
representation of the measurement signal or measured variable,
processing of the measurement signal or measured variable; and
using a computer program product for the setting and monitoring of process parameters;
displaying each process parameter on a graphical user interface in a window specifically assigned thereto and that is selectively collapsible to a space on the graphical user interface that is necessary for displaying the corresponding process parameters in a short form and that is selectively expandable to a space on the graphical user interface that is necessary for displaying the corresponding process parameters in a long form.

2. The process according to claim 1, wherein a plurality of physical measured variables are measured simultaneously; and wherein each of the process parameters of the measurements is displayed on the graphical user interface in a window specifically assigned to the process parameter.

3. The process according to claim 1, wherein windows with the corresponding process parameters are displayed in columns, and wherein the columns may be activated and deactivated, wherein the windows of a deactivated column are collapsed; and the windows of an activated column are expanded.

4. The process according to claim 3, wherein a deactivated column is selected by moving a cursor across a data input device; and wherein a selected deactivated column is activated by pressing a key of a data input device.

5. The process according to claim 3, wherein an activated column is selected by moving a cursor across a data input device; and wherein a selected activated column is deactivated by pressing a key of the data input device.

6. The process according to claim 1, wherein the process parameters are classified in categories, wherein a first category of process parameters comprises a plurality of measuring units required for measuring the physical measured variable, a second category comprises at least one detection of the physical measured variable as the measurement signal, a third category comprises at least one evaluation of the measurement signal for obtaining a measured variable, a fourth category comprises at least one representation of the measurement signal or measured variable, and a fifth category comprises at least one processing of the measurement signal or measured variable; and wherein each column shows windows of process parameters of one and the same category.

7. The process according to claim 1 wherein windows with their corresponding process parameters may be activated and deactivated; process parameters of one and the same measuring unit are linked to each other; and wherein windows of process parameters linked to the process parameter of the activated window are selected by activating a deactivated window.

8. The process according to claim 7, wherein a deactivated window is selected by moving a cursor across a data input device; and wherein a selected deactivated window is activated by pressing a key of the data input device.

9. Process according to claim 7, wherein an activated window is selected by moving a cursor across a data input device; and wherein a selected activated window is deactivated by pressing a key of the data input device.

10. The process according to claim 1, wherein the representation of a process parameter in short form uses a minimum space of less than 5% of the graphical user interface.

11. The process according to claim 1, wherein the representation of a process parameter in long form uses a maximum space of more than 50% of the graphical user interface.

12. The process according to claim 1, wherein a process parameter is represented in a collapsed window assigned thereto with a fine structure.

13. The process according to claim 1, wherein collapsed windows show a status notification of the process parameters of the measuring system in the graphical user interface.

14. A measuring system for carrying out the process according to claim 1, wherein the process parameters are classified in categories, wherein a first category of process parameters comprises a plurality of measurement units required for measuring the physical measured variable, a second category comprises at least one detection of the physical measured variable as the measurement signal, a third category comprises at least one evaluation of the measurement signal for obtaining a measured variable, a fourth category comprises at least one representation of the measurement signal or measured variable, and a fifth category comprises at least one processing of the measurement signal or measured variable; wherein each category has a unique index number; and wherein the computer program product displays the windows of process parameters having the same index number in at least two columns on the graphical user interface.

15. The measuring system according to claim 14, wherein the process parameters of one and the same measuring unit have a unique identification number; and wherein upon activation of a deactivated window the computer program product selects windows of process parameters with the same identification number as the process parameters assigned to the activated window on the graphical user interface.
